(19) United States
(12) Patent Application Publication
(10) Pub. No.: US 2014/0212706 A1
(43) Pub. Date: Jul. 31, 2014

(54) BATTERY PACK, METHOD OF WELDING TAB OF BATTERY BACK, AND BATTERY PACK CONTROL SYSTEM

(71) Applicant: Samsung SDI Co., Ltd., Yongin-si (KR)

(72) Inventors: Hun-Tae Ro, Yongin-si (KR); Kwang-Soo Bae, Yongin-si (KR)

(21) Appl. No.: 13/920,994

(22) Filed: Jun. 18, 2013

(30) Foreign Application Priority Data
Jan. 28, 2013 (KR) 10-2013-0009503

(51) Int. Cl. H01M 2/30

(52) U.S. Cl. CPC H01M 2/30
USPC 429/10; 228/175

(57) ABSTRACT

An apparatus and method of welding a tab of a battery pack, is disclosed. Batteries are placed on a main body of a jig, having a wing unit attached to the jig. A tab is attached to the wing unit, the wing unit being rotatably connected to the main body of the jig. The method includes attaching the tab to a wing unit of the jig by using an adhesive member, welding the terminals of the batteries to the tab, and separating the wing unit from the tab.

### CROSS-REFERENCE TO RELATED APPLICATIONS

This application claims the benefit of Korean Patent Application No. 10-2013-0009503, filed on Jan. 28, 2013, in the Korean Intellectual Property Office, the disclosure of which is incorporated herein in its entirety by reference. Any and all priority claims identified in the Application Data Sheet, or any correction thereto, are hereby incorporated by reference under 37 CFR 1.57.

### BACKGROUND

1. Field

The present disclosure relates to battery packs, and more particularly, to battery packs in which terminals of the battery pack and tabs may be stably welded and the battery pack may be effectively controlled. The disclosure also relates to methods of welding tabs of the battery packs and a battery pack control system.

2. Description of the Related Technology

A battery pack may be manufactured by binding a plurality of batteries into a bundle and connecting tabs to terminals of the batteries.

Generally, tabs are connected to the terminals of batteries using a welding or soldering process. In order to correctly and solidly weld/solder the tabs and terminals of batteries, the tabs and terminals are mounted on a jig, and are then welded or soldered. For example, the jig disclosed in Korea Patent Publication No. 2008-0037441 is manufactured in consideration of a structure and size of the battery pack, and thus, the jig supports the batteries and tabs so that the batteries and tabs stably contact each other during a welding or soldering process.

A nickel material is generally used to manufacture tabs for battery packs. A copper material, which is relatively inexpensive, is also used. However, when a copper material is used, it is not easy to place tabs made of the copper material on a jig. That is, since copper is a non-magnetic material, the tabs formed of the copper material do not adhere to a magnet on soldering, and, as a result, a weld or solder failure may occur, and the contact between terminals of batteries and tabs is not well maintained.

### SUMMARY OF CERTAIN INVENTIVE ASPECTS

One or more embodiments disclosed herein include methods of welding tabs of battery packs, whereby terminals of batteries of the battery pack and tabs are precisely and stably welded.

One or more embodiments include battery packs having a magnet that enables detection of the presence of battery packs, and battery pack control systems that efficiently control the battery packs by detecting the presence thereof.

Additional aspects will be set forth in part in the description which follows and, in part, will be apparent from the description, or may be learned by practice of the presented embodiments.

In one aspect, a method of welding a tab of a battery pack comprises disposing a plurality of batteries on a main body of a jig; attaching the tab to a wing unit which is connected to the main body of the jig, the tab having electrical conductivity and being formed of a non-magnetic material, wherein the tab adheres to the wing unit via an adhesive member disposed between the tab and the wing unit; contacting the tab attached to the wing unit of the jig to one or more terminals of the batteries by moving the wing unit into a position proximate the batteries; welding the tab to at least one of the terminals of each of the plurality of the batteries; and separating the wing unit from the tab, wherein the adhesive member remains adhered to the tab.

In some embodiments, the method further comprises attaching an insulating member to the adhesive member adhered to the tab after separating the wing unit from the tab.

In some embodiments, the wing unit is rotatably connected to the main body of the jig to rotate between a first position that is away from the terminals of the batteries and a second position that is adjacent to the terminals of the batteries.

In some embodiments, the wing unit is formed with one or more welding holes therethrough, the welding holes exposing a surface of the tab which is adhered to the wing unit.

In some embodiments, the method further comprises attaching a magnetic body to the adhesive member.

In some embodiments, the adhesive member is an adhesive tape having adhesive layers on both surfaces thereof.

In some embodiments, welding the tab comprises inserting a welding tool through the welding holes in the wing unit and contacting the tab through the welding holes.

In some embodiments, the tab comprises copper.

In another aspect, a battery pack comprises a plurality of batteries; a tab comprising a non-magnetic material, the tab having a first surface and a second surface, the first surface welded to at least a part of one or more terminals of the plurality of batteries; an adhesive member connected to the second surface of the tab a magnetic body attached to the adhesive member by using the adhesive member, such that the magnetic body is attached proximate the second surface of the tab.

In some embodiments, the battery pack further comprises an insulating member attached to the adhesive member on the second surface of the tab, such that the insulating member covers the magnetic body.

In some embodiments, the adhesive member is an adhesive tape having adhesive layers on both surfaces thereof.

In some embodiments, the tab comprises a non-magnetic material.

In some embodiments, the tab comprises copper.

In another aspect, a battery pack control system comprises a battery pack comprising: a plurality of batteries, a tab having a first and second surface, the first surface welded to at least a part of one or more terminals of the plurality of batteries, and a magnetic body attached to the second surface of the tab; a magnetic sensing unit configured to generate a sensing signal upon sensing the magnetic body of the battery pack; and a control unit that is electrically connected to the tab of the battery pack configured to control charging or discharging of the battery pack in response to the sensing signal received from the magnetic sensing unit.

### BRIEF DESCRIPTION OF THE DRAWINGS

These above and/or other aspects will become apparent and more readily appreciated from the following description of the embodiments, taken in conjunction with the accompanying drawings.

FIG. 1 is a flowchart illustrating a method of welding tabs of a battery pack.

FIG. 2 is a perspective view of method jig for welding tabs of a battery pack of FIG. 1.

FIG. 3 is a lateral cross-sectional view of welding of the tabs of the battery pack of FIG. 2.

FIG. 4 is a lateral cross-sectional of an apparatus attaching an insulating member to the battery pack of FIG. 3.

FIG. 5 is a perspective view of a battery pack manufactured by the method of welding tabs of a battery pack of FIG. 1.

FIG. 6 is an exploded perspective view of welding tabs of a battery pack.

FIG. 7 is a perspective view illustrating attaching an insulating member to the battery pack of FIG. 6.

FIG. 8 is a schematic block diagram of a battery pack control system according.

FIG. 9 is a flowchart illustrating operation of the battery pack control system of FIG. 8.

### DETAILED DESCRIPTION

The following disclosure, along with reference to the accompanying drawings, describes in detail some exemplary embodiments. The present development may, however, be embodied in many different forms and should not be construed as being limited to the embodiments set forth herein; rather, these embodiments are provided so that this disclosure will be thorough and complete, and will fully convey the concept of the invention to those of ordinary skill in the art.

The terminologies used herein are for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, and/or components, and/or groups thereof. It will be understood that, although the terms first, second, etc. may be used herein to describe various elements, these elements should not be limited by these terms. These terms are only used to distinguish one element from another.

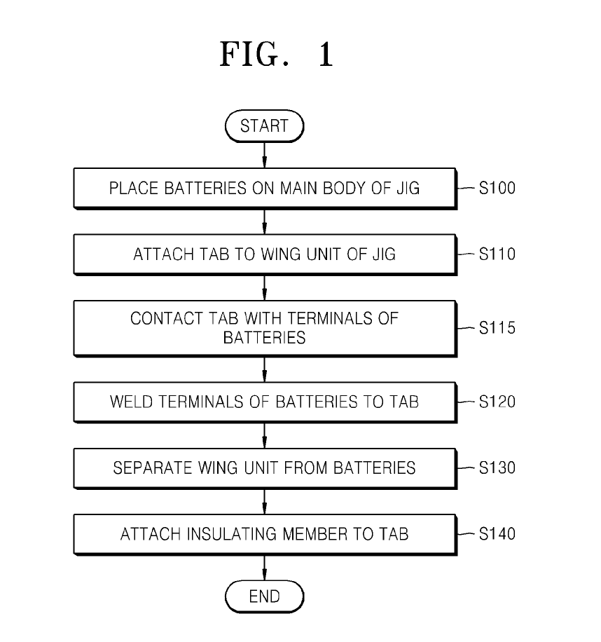

FIG. 1 is a flowchart showing a method of welding tabs of a battery pack according to an embodiment of the present invention. The process of welding or soldering tabs of a battery pack according may begin with step S100, wherein batteries are disposed on a main body of a jig. The process moves to step S110, wherein tabs are attached on wing units of the jig. The jig and the wing units will be described in greater detail below. Following step S110, the terminals of the batteries are welded or soldered to the tabs in step S120. The process moves to step S130, wherein the wing units of the jig are separated from the terminals of the batteries. The process may proceed to step S140, wherein an insulating member is attached to an adhesive member on the tabs. A person of skill in the art will understand that the steps of the process above may be performed in any logical or suitable order and that one or more steps may be omitted without departing from the scope of the present disclosure.

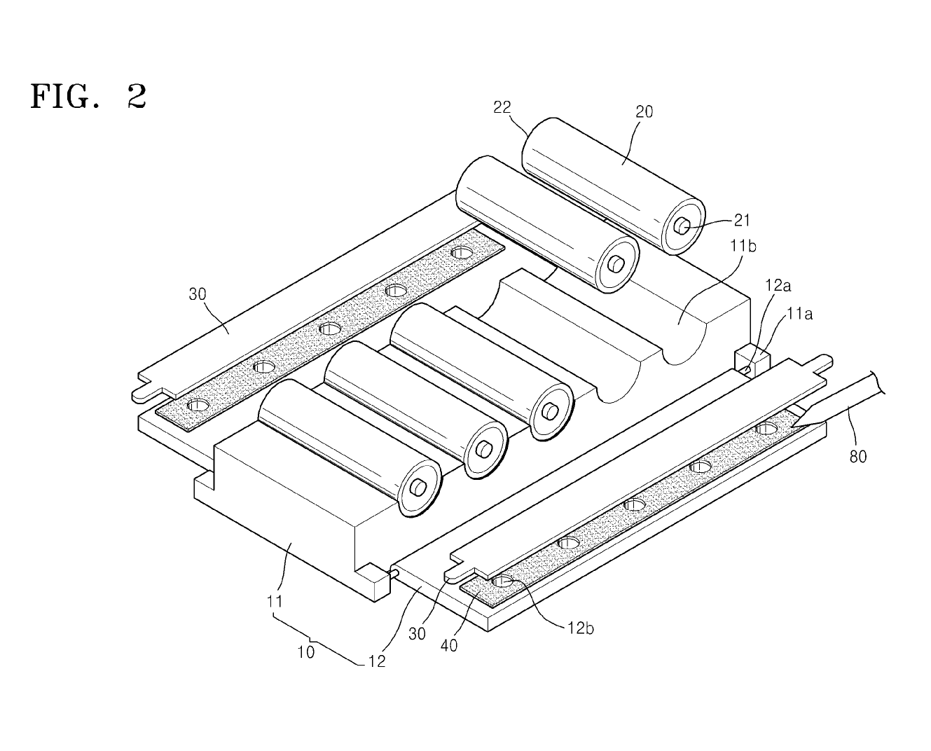

The process of FIG. 1 will be described more fully with reference to the following figures. FIG. 2 is a perspective view of a jig for welding or soldering tabs of a battery pack of FIG. 1. In FIG. 2, the batteries 20 have a cylindrical shape, each including a first terminal 21 on a first side and a second terminal 22 on a second side. The jig 10 includes two wing units 12 connected to a main body 11, one wing unit 12 connected to opposing sides of the main body, one wing unit 12 corresponding to the first terminals 21 and one wing unit corresponding to the second terminals 22 of the batteries 20.

A jig 10 for welding or soldering a plurality of batteries 20 to tabs 30 comprises the main body 11 that supports each of the batteries 20 and wing units 12 that support the tabs 30.

The main body 11 includes a plurality of indentations or grooves 11b where the batteries 20 are seated. The indentations or grooves 11b may be sized and shaped to receive and support a battery having a variety of form factors, including AA, AAA, C, D, 9V, CR123, or any other desired form factor. The plurality of batteries 20 may be disposed such that terminals 21 of each of the plurality of batteries 20 are aligned. The wing units 12 are rotatably connected to the sides of the main body 11. Each wing unit 12 comprises a supporting member 12a of the wing units 12. The supporting member 12a is rotatably inserted into corresponding supporting units 11a, connected to the main body 11. In this arrangement, the wing units 12 are rotatable about an axis perpendicular to the direction in which the terminals 21 are aligned or pointed. The wing units 12 are similarly rotatable with respect to the main body 11.

As depicted in FIG. 2, the wing units 12 may rotate between a first position, wherein the tabs 30 are disposed away from terminals 21 and 22 of the batteries 20 and a second position wherein the tabs 30 are adjacent to or, in some embodiments, in contact with the terminals 21 and 22 of the batteries 20. The wing units 12 include welding holes 12b that expose the electrical conductive tab 30 to the outside. A plurality of the welding holes 12b may be formed in the wing unit 12 and may be disposed along the wing unit 12 in order to correspond to the number of batteries 20 disposed on the main body 11. For example, the welding holes 12b may be disposed within the wing unit so as to be in close proximity to the terminals 21 or 22 when the wing unit 12 is rotated to the second position. Each welding hole 12b may correspond to a single terminal 21 or 22 of one of the plurality of batteries 20.

The wing units 12 of the jig 10 support the tabs 30 so that the terminals 21 and 22 of the batteries 20 and the tabs 30 stably contact each other during welding or soldering.

Each wing unit 12 may comprise an adhesive member 40. The adhesive member 40 is used to contact tabs 30 and attach tabs 30 to the wing units 12. For example, the adhesive member 40 may be an adhesive coated on the wing units 12. In some embodiments, the adhesive member 40 may be an adhesive tape or other substance adhered on one side to the wing unit 12. The adhesive member 40 is disposed on surfaces of the wing units 12. In some embodiments, the adhesive member 40 is not disposed over the welding holes 12b. The adhesive member 40 may be applied by using an adhesive supplying unit 80. The tabs 30 may be placed in contact with the adhesive member, thereby attaching the tabs 30 to the adhesive member 40. Accordingly, the tabs 30 are adhered to the wing units 12 by the adhesive member 40 while the wing units 12 rotate with respect to the main body 11 of the jig 10.

Placing the batteries 20 in step S100 of FIG. 1 may correspond to the mounting of the batteries 20 in each of the grooves 11b of the main body 11. The attaching of the tabs 30 to the wing units 12 in step S110 of FIG. 1 may correspond to the attaching the tabs 30 to the wing units 12 using the adhesive member 40.

Steps S100 and S110 need not be performed in the order specified. That is, the attaching of the tabs 30 in step S110 may be performed prior to disposing of the batteries 20 in step S100. In some embodiments, the steps may be performed at the same time.

After the tabs 30 attached to the wing units 12 are welded or soldered to the first terminal 21 and the second terminal 22 of the batteries 20, the tabs 30 may perform a function of conducting electricity. The tabs 30 may be electrically conductive and may comprise a non-magnetic material. For example, the tabs 30 may comprise copper.

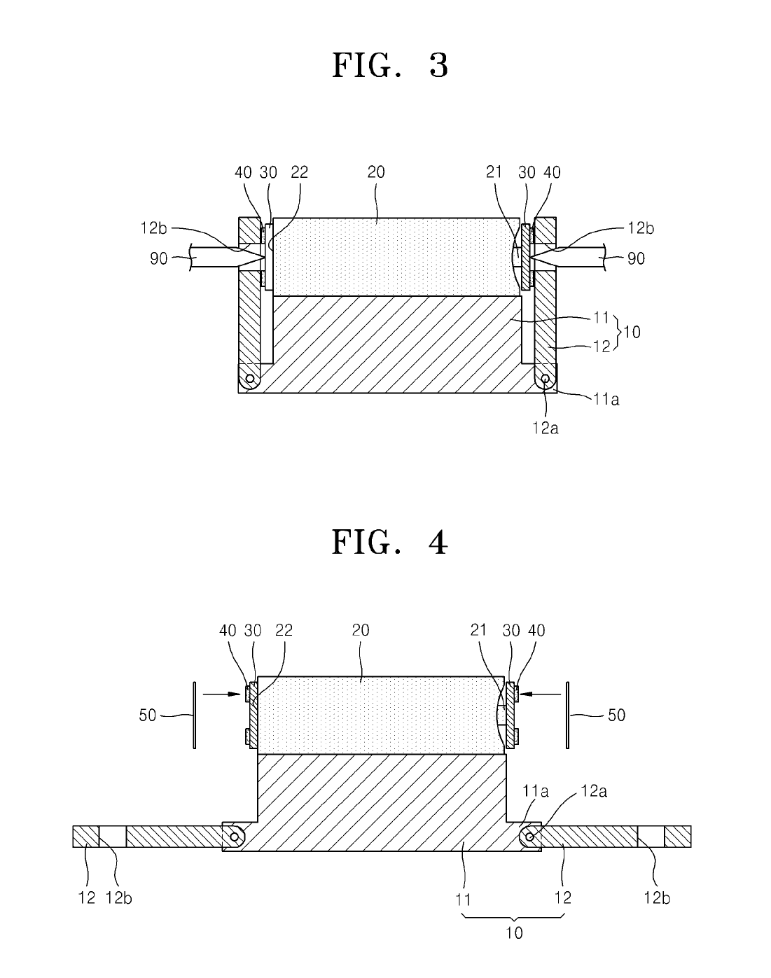

FIG. 3 is a lateral cross-sectional view illustrating an embodiment of a process of welding the tabs 30 of the batteries 30. FIG. 3 shows the wing units 12 in a second position, with tabs 30 in contact with terminals 21 and 22 of the batteries 20 and the welding of the terminals 21 and 22 of the batteries 20 with the tabs 30.

After the tabs 30 are attached to the wing units 12, the tabs 30 attached to the wing units 12 may contact the terminals 21 and 22 of the batteries 20 by moving the wing units 12 into the first position, close to the batteries 20. The tabs 30 attached to surfaces of the wing units 12 may contact the terminals 21 and 22 of the batteries 20 by rotating the wing units 12 with respect to the main body 11 of the jig 10, while the tabs 30 are maintained attached to the wing units 12 by the adhesive member 40.

Accordingly, as depicted in FIG. 3, the tabs 30 and the terminals 21 and 22 of the batteries 20 are maintained in a stable contact state while a welding process is performed by contacting a welding rod 90 to the surfaces of the tabs 30 via the weld holes 12b.

FIG. 4 is a lateral cross-sectional view illustrating an embodiment of a process of attaching an insulating member to the battery pack. FIG. 4 depicts the wing units 12 in a first position, away from the batteries 30. The tabs 30 are welded or soldered to the terminals 21 and 22, and the adhesive members 40 is still adhered to the tab, separated from the wing units 12. FIG. 4 illustrates separating of the wing units 12 from the batteries 20, according to step S130, and the attaching of an insulating member to the tabs 30, according to step S140 of FIG. 1. When the welding or soldering of the tabs 30 to the terminals 21 and 22 of the batteries 20 is completed, the wing units 12 may be separated from the terminals 21 and 22 of the batteries 20. Since the tabs 30 are welded to the terminals 21 and 22 of the batteries 20 and the tabs 30 are attached to the wing units 12 by the adhesive member 40, the separation of the wing units 12 may be realized by applying a force to the wing units 12 to move the wing units 12 away from the tabs 30 and from the adhesive member 40. The adhesive member 40 that allows the tabs 30 to adhere to the wing units 12 may be unhardened for easy separation from the wing units 12.

When the wing units 12 are separated from the tabs 30, as depicted in FIG. 4, after rotating the wing units 12 with respect to the main body 11 of the jig 10, an insulating member 50 is attached to the adhesive member 40 that remained attached to the tabs 30. The insulating member 50 electrically insulates the tabs 30 from the terminals 21 and 22 of the batteries 20 and protects the tabs 30 and the batteries 20.

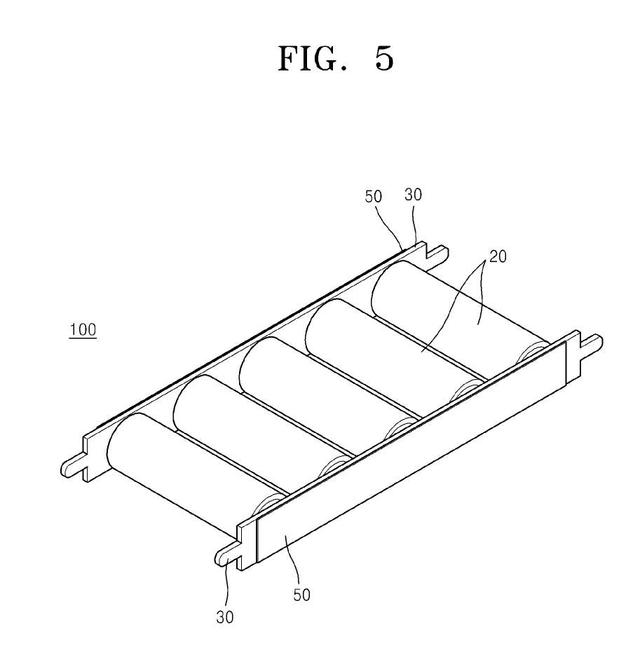

FIG. 5 is a perspective view a battery pack 100 manufactured by the method of welding or soldering tabs of a battery pack of FIG. 1. The battery pack 100 depicted in FIG. 5 is manufactured by the welding or soldering method described with reference to FIGS. 1 through 4. The batteries 20 of the battery pack 100 are electrically connected by the tabs 30, and the insulating member 50 is attached to the surfaces of the tabs 30. The structure of the battery pack 100 manufactured by the method of welding the tabs 30 of the battery pack according to the current embodiment is not limited to the structure depicted in FIG. 5, that is, the numbers of the batteries 20, the shapes of the insulating member 50 and the tabs 30, and the connection structure of the tabs 30 and the batteries 20 may vary.

The method of welding the tabs 30 of the battery pack as shown in FIGS. 1 through 5, can be performed in a state where the tabs 30 formed of a non-magnetic material such as copper are attached to the wing units 12 of the jig 10 by the adhesive member 40. This method can prevent the tabs 30 from falling of the jig 10 or separating from the terminals 21 and 22 of the batteries 20 may be prevented, and thus, welding failure may be minimized.

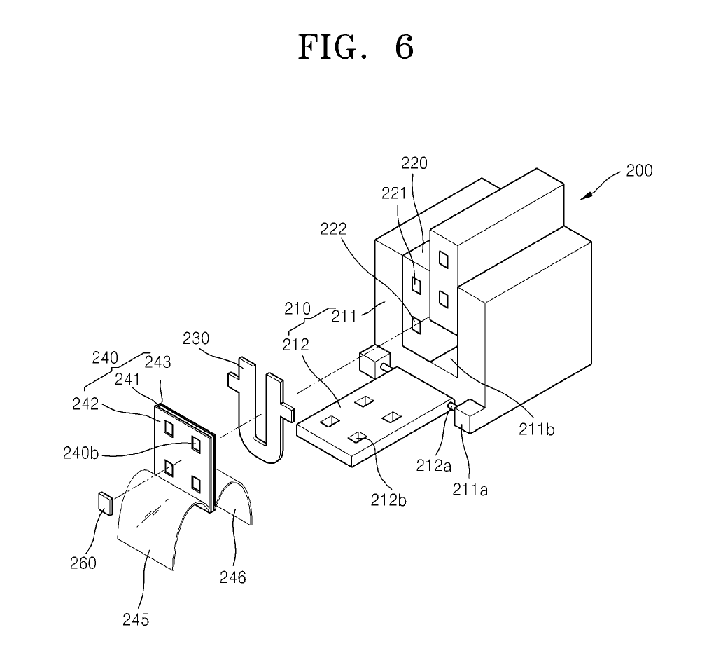

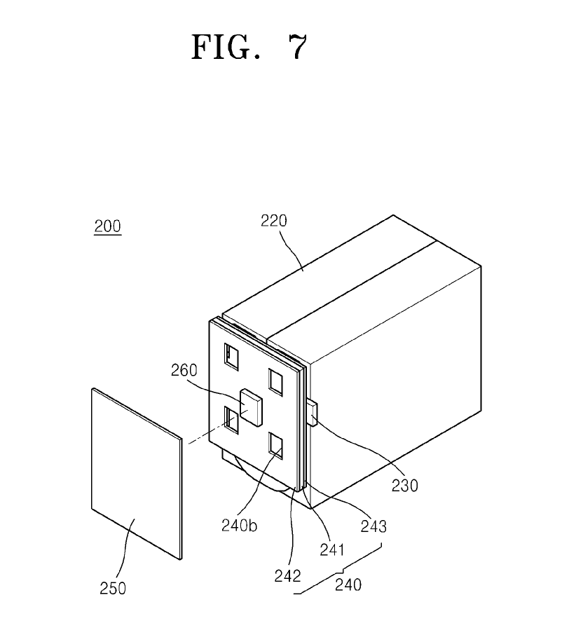

FIG. 6 is an exploded perspective view illustrating an embodiment of welding a tab 230 of a battery pack 200. FIG. 7 is a perspective view illustrating an embodiment of a process for attaching an insulating member to the battery pack 200 of FIG. 6.

The embodiment of FIGS. 6 and 7 shows a method of welding the tab 230 of the battery pack 200 having rectangular batteries 220.

In the method of welding the tabs of the battery pack 200 depicted in FIGS. 6 and 7, a plurality of batteries 220 and a jig 210 that supports the tab 230 are used. The jig 210 includes a main body 211 that supports the batteries 220 and a wing unit 212 that supports the tab 230.

The main body 211 includes grooves 211b into which the batteries 220 are inserted. The wing unit 212 is rotatably attached to a side of the main body 211 similar to that described elsewhere herein. A supporting member 212a of the wing unit 212 is rotatably inserted into supporting units 211a of the main body 211, and thus, the wing unit 212 may rotate with respect to the main body 211.

The wing unit 212 may rotate between a first position away from terminals 221 and 222 of the batteries 220 and a second position adjacent to the terminals 221 and 222 of the batteries 220.

The wing unit 212 includes welding holes 212b that run through the wing unit 212, and provide access to portions of the surface of the tab 230 which is to be connected to the wing unit 212. The welding holes 212b may be formed and disposed within the wing unit 212 to correspond to the location and quantity of the terminals 221 and 222 of the batteries 220 disposed within the groove 211b of the main body 211.

The wing unit 212 of the jig 210 supports the tab 230 in a second position so that the terminals 221 and 222 of the batteries 220 and the tab 230 are held in stable contact while the tabs 230 are welded or soldered to the terminals 221 and 222 of the batteries 220.

After the tabs 230 attached to the wing unit 212 are welded to the terminals 221 and 222 of the batteries 220, the tabs 230 can conduct and/or transmit electricity between terminals of the batteries 220. The tab 230 may be electrically conductive and may comprise a non-magnetic material. For example, in some embodiments, the non-magnetic material may be copper.

An adhesive member 240 is used to attach the tab 230 the wing unit 212. In some embodiments, the adhesive member 240 may be a dual sided tape having a base tape 241 and adhesive layers 242 and 243 disposed on either surface of the base tape 241. As depicted in FIG. 6, after removing covers 245 and 246 from the adhesive member 240, an adhesive surface of the adhesive layers 242 and 243 is exposed. The adhesive member 240 is attached to the wing unit 212 of the jig 210, via adhesive layer 242, and the tab 230 is attached to the adhesive layer 243.

In some embodiments, a magnetic body 260 may be attached to the adhesive layer 242 of the adhesive member 240 that is attached to the tab 230. The wing unit 212 may be formed of a material having a magnetic property configured to respond to a magnetic force exerted by the magnetic body 260 so that the magnetic body can be releasable held to the wing unit 212.

When the tab 230 is attached to the wing unit 212, holes 240b in the adhesive member 240 may be aligned with the welding holes 212b of the wing unit 212. After the tab 230 is attached to the wing unit 212 by using the adhesive member 240, the tab 230 is brought into contact with the terminals 221 and 222 of the batteries 220 by rotating wing unit 212 from a first position to a second position. Since the wing unit 212 rotates with respect to the main body 211 of the jig 210, the tab 230 attached to a surface of the wing unit 212 may contact the terminals 221 and 222 of the batteries 220.

Welding or soldering the tab 230 to the terminals 221 and 222 of the batteries 220 may be performed with the wing unit 212 in a second position, with the tab 230 in contact with terminals 221 and 222 of the batteries 220. The tab 230 is maintained in an attached state to the wing unit 212 by the adhesive member 240 when the welding process is performed. The welding process may be done by contacting a welding rod (not shown) with the tab 230 through welding holes 212b of the wing unit 212 and the holes 240b of the adhesive member 240.

After welding the terminals 221 and 222 to the tab 230 is completed, the wing unit 212 may be separated from the tab 230 and the terminals 221 and 222 of the batteries 220. Since the tab 230 is welded to the terminals 221 and 222 of the batteries 220 and the tab 230 is attached to the wing unit 212 by the adhesive member 240, the separation of the wing unit 212 from the terminals 221 and 222 of the batteries 220 may be achieved by rotating the wing unit 212 from the second position to the first position, thereby separating the tab 230 and the adhesive member 240.

After the wing unit 212 is separated from the tab 230 and the adhesive member 240, an insulating member 250 may be attached to the adhesive member 240. The insulating member 250 electrically insulates the tab 230 from the terminals 221 and 222 of the batteries 220, and protects the tab 230 and the batteries 220.

FIG. 7 is a perspective view of an embodiment of a battery pack 200 is manufactured by the welding method described with reference to FIG. 6. The battery pack 200 includes a plurality of batteries 220, a tab 230 having a surface welded to at least some of the terminals (not shown) of the batteries 220, a magnetic body 260 attached to other surface of the tab 230 by using the adhesive member 240, and an insulating member 250 attached to the adhesive member 240 to cover the magnetic body 260.

The batteries 220 of the battery pack 200 are electrically connected by the tab 230, and the magnetic body 260 and the insulating member 250 are attached to the surface of the tab 230. The structure of the battery pack 200 is not limited to the structure depicted in FIG. 7, that is, the numbers of the batteries 220, the shapes of the insulating member 250 and the tab 230, and the connection structure of the tab 30 and the batteries 220 may be different without departing from the scope of the present disclosure.

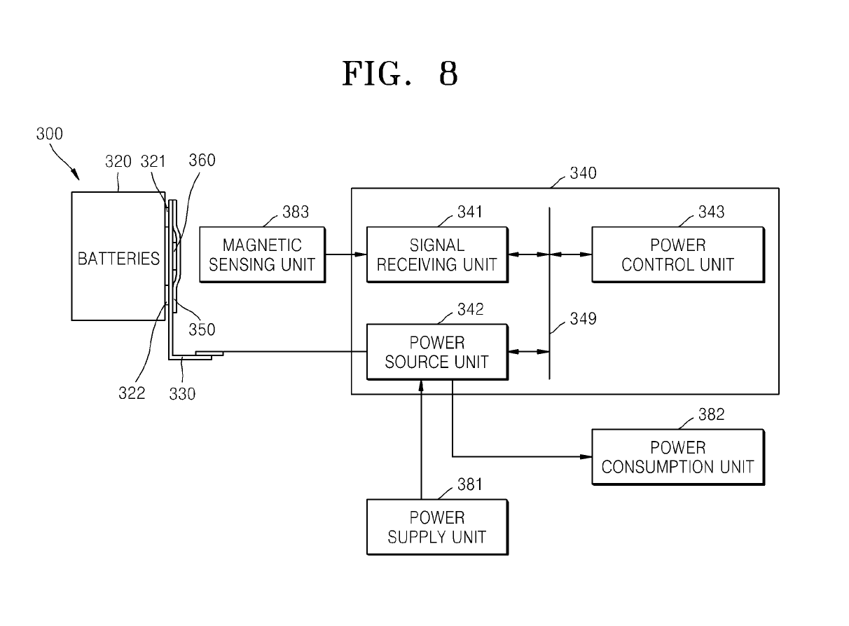

FIG. 8 is a schematic block diagram of an embodiment of a battery pack control system.

The battery pack control system according to the current embodiment performs a function of controlling a battery pack 300 having batteries 320, a tab 330 having a surface welded to terminals 321 and 322 of the batteries 320, a magnetic body 360 attached to a surface of the tab 330, and an insulating member 350.

The battery pack control system includes a battery pack 300, a magnetic sensing unit 383 that generates a signal upon sensing the magnetic body 360 of the battery pack 300, and a control unit 340 electrically connected to the tab 330 of the battery pack 300. and the battery pack control system is configured to control charging and discharging of the battery pack 300 in response to the sensing signal received from the magnetic sensing unit 383.

The control unit 340 may be formed in, for example, a circuit substrate type having a semiconductor chip and electrical parts in a semiconductor chip on which software is mounted, or in a computer.

The control unit 340 may include a signal receiving unit 341, a power control unit 343, and a power source unit 342, which exchange signals by being connected via a signal bus 349. The control unit 340 is electrically connected to a power supply unit 381 and a power consumption unit 382. The control unit 340 is configured to receive a sensing signal from the magnetic sensing unit 383. Power supply unit 381 is configured to supply power to the battery pack 300 The control unit 340 is further configured to receive power from the battery pack 300 and to supply power from the battery pack 300 to the power consumption unit 382.

The signal receiving unit 341 is configured to sense whether the battery pack 300 is mounted at a correct position or not by receiving a sensing signal from the magnetic sensing unit 383. The magnetic sensing unit 383 senses a magnetic force or field generated by the magnetic body 360 of the battery pack 300. In some embodiments, magnetic sensing unit 383 may be a sensor such as a hall sensor that senses a magnetic force.

The power control unit 343 may control charging of the battery pack 300 by supplying power from the power supply unit 381 to the battery pack 300, or may control discharging of the battery pack 300 by supplying power from the battery pack 300 to the power consumption unit 382 by controlling the power source unit 342 in response to a signal received by the signal receiving unit 341 from the magnetic sensing unit 383. The power consumption unit 382 may be, for example, a portable electronic device, an electronic device of an electric car, or any other desired power consumption device.

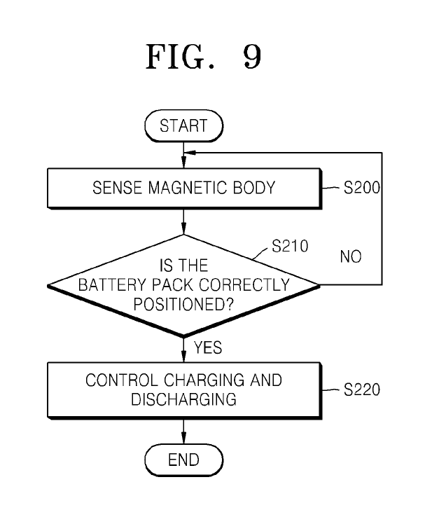

FIG. 9 is a flowchart describing operation of the battery pack control system of FIG. 8.

The process begins, and senses the presence of a magnetic body sensing in step S200. The magnetic body 360 is sensed via the magnetic sensing unit 383. The process next proceeds to step S210, wherein it is determined whether the battery pack 300 is mounted at the correct position. If it is determined in step S210 that the battery pack 300 is not at the correct position, the process returns to step S200. If the battery pack 300 is sensed in the correct position, the process proceeds to step S220, wherein the control unit 340 controls the charging and discharging of the battery pack 300.

The battery pack control system according to the current embodiment described with reference to FIGS. 8 and 9 senses a magnetic body mounted on a battery pack, and controls charging and discharging of the battery pack in response to a sensing signal. Thus, the battery pack may be efficiently controlled.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of welding a tab of a battery pack, the method comprising:
placing a plurality of batteries on a main body of a jig;
attaching the tab to a wing unit which is connected to the main body of the jig, the tab having electrical conductivity and being formed of a non-magnetic material, wherein the tab adheres to the wing unit via an adhesive member disposed between the tab and the wing unit;
contacting the tab attached to the wing unit of the jig to one or more terminals of the batteries by moving the wing unit into a position proximate the batteries;
welding the tab to at least one of the terminals of each of the plurality of the batteries; and
separating the wing unit from the tab, wherein the adhesive member remains adhered to the tab.

2. The method of claim 1, further comprising attaching an insulating member to the adhesive member adhered to the tab after separating the wing unit from the tab.

3. The method of claim 1, wherein the wing unit is rotatably connected to the main body of the jig to rotate between a first position that is away from the terminals of the batteries and a second position that is adjacent to the terminals of the batteries.

4. The method of claim 3, wherein the wing unit is formed with one or more welding holes therethrough, the welding holes exposing a surface of the tab which is adhered to the wing unit.

5. The method of claim 3, further comprising attaching a magnetic body to the adhesive member.

6. The method of claim 1, wherein the adhesive member is an adhesive tape having adhesive layers on both surfaces thereof.

7. The method of claim 1, wherein the adhesive member is an adhesive to be coated on the wing unit.

8. The method of claim 4, wherein welding the tab comprises inserting a welding tool through the welding holes in the wing unit and contacting the tab through the welding holes.

9. The method of claim 1, wherein the tab is formed of copper.

10. A battery pack comprising:
a plurality of batteries;
a tab that is formed of a non-magnetic material, the tab having a first surface and a second surface, the first surface welded to at least a part of one or more terminals of the plurality of batteries;
an adhesive member connected to the second surface of the tab
a magnetic body attached to the adhesive member by using the adhesive member, such that the magnetic body is attached proximate the second surface of the tab.

11. The battery pack of claim 10, further comprising an insulating member attached to the adhesive member on the second surface of the tab, such that the insulating member covers the magnetic body.

12. The battery pack of claim 10, wherein the adhesive member is an adhesive tape having adhesive layers on both surfaces thereof.

13. The battery pack of claim 10, wherein the adhesive member is an adhesive.

14. The battery pack of claim 10, wherein the tab is formed of a non-magnetic material.

15. The battery pack of claim 10, wherein the tab comprises copper.

16. A battery pack control system comprising:
a battery pack comprising:
a plurality of batteries,
a tab having a first and second surface, the first surface welded to at least a part of one or more terminals of the plurality of batteries, and
a magnetic body attached to the second surface of the tab;
a magnetic sensing unit configured to generate a sensing signal upon sensing the magnetic body of the battery pack; and
a control unit that is electrically connected to the tab of the battery pack configured to control charging or discharging of the battery pack in response to the sensing signal received from the magnetic sensing unit.
